(19) United States
(12) Patent Application Publication
(10) Pub. No.: US 2005/0003093 A1
(43) Pub. Date: Jan. 6, 2005

(54) Process for the preparation of a coating, a coated substrate, an adhesive, film or sheet

(75) Inventors: Laurentis Cornelis Josephus Hesselmans, 's-Hertogenbosch (NL); Johanna Antonia Maria Van den Goorberg, Waalwijk (NL)

Correspondence Address: PEACOCK MYERS AND ADAMS P C, P O BOX 26927, ALBUQUERQUE, NM, 871256927, US

(73) Assignee: STAHL INTERNATIONAL B.V., Waalwijk (NL)

(21) Appl. No.: 10/783,165

(22) Filed: Feb. 19, 2004

Related U.S. Application Data
(63) Continuation-in-part of application No. PCT/NL02/00555, filed on Aug. 21, 2002.

(30) Foreign Application Priority Data
Aug. 22, 2001 (NL) NL 1018796

(51) Int. Cl. B05D 3/02

(52) U.S. Cl. 427/372.2

(57) ABSTRACT

A process for the preparation of a coating, a coated substrate, an adhesive, film or sheet or the like, which process comprises the application of a coating mixture containing a reactive system onto a substrate. According to the invention a coating mixture is used which comprising at least two reactive system and after application of the coating mixture the first reactive system is substantially reacted under conditions where the second reactive system is substantially not reacted. Thereafter the coated substrate is remoulded at elevated temperature and the second reactive system is substantially reacted during or after the remoulding of the coated substrate resulting in a fixed remoulded coating.

The present invention relates to a process for the preparation of a coating, a coated substrate, an adhesive, film or sheet, to the thus obtained product and to a coating mixture to be used in the process.

In the course of years several methods have been developed for solvent-free application of polyurethanes in the preparation of coatings, films and the like. An overview of these methods is presented in WO-123451. Further, in this patent application an invention is described which caused a breakthrough in the development of high solid systems. This invention describes a process for the preparation of coatings in which a mixture of a polyisocyanate-, polyepoxide-, polyanhydride-, or polyketone-functional compound and a compound containing reactive hydrogen, which mixture is not reactive at room temperature, is applied onto a substrate, whereafter the mixture reacts at elevated temperatures. The compound containing reactive hydrogen is a solid, which may be present in the mixture as a fine powder or as a dispersion in a medium.

In some applications the known systems, including the system described in WO-123451, have the disadvantage that after reaction the material retains its form so well that treatment such as embossing or otherwise moulding and subsequent fixing of the form, poses problems.

The object of the present invention is to provide a process in which the disadvantages mentioned are eliminated and in which is taken advantage of the invention described in WO-123451.

According to the present invention there is provided a process for the preparation of a coating, coated substrate, adhesive, film, sheet and the like which comprises:
the preparation of a coating mixture comprising a reactive system,
applying of the coating mixture onto a substrate resulting in a substrate coated with the coating mixture and
reacting the reactive system, characterized, in that, the coating mixture is prepared as a mixture comprising a first and a second reactive system, after the application of the coating mixture the first reactive system is substantially reacted under conditions where the second reactive system is substantially not reacted,
after substantially reacting the first reactive system at elevated temperatures the coated substrate is remoulded resulting in a remoulded coating, and
the second reactive system is substantially reacted during or after the remoulding of the coated substrate, resulting in a fixed remoulded coating; which means that the first reactive system and the second reactive system are essentially reacted as a sequential two-step reaction.

Surprisingly the technical problems known in the art are solved. After the first reaction step a remouldable material is formed and after the second reaction step the remoulding is fixed by using the two-step reaction. A second advantage is that the material formed in the two-step reaction is extra strong and resistant. Moreover crosslinking or the formation of polymer networks can be achieved by the use of the two-step reaction.

Advantageously a coating mixture is prepared in which one reactive system from the first and the second reactive system comprises i) a compound with at least one isocyanate functionality, preferably a polyisocyanate, and ii) a compound with at least one reactive hydrogen, and the selected reactive system is non-reactive or hardly reactive at room temperature.

Preferably the compound containing reactive hydrogen is a polyhydrazide- and/or polysemicarbazide-functional compound and/or carbodihydrazide.

Preferably the polyhydrazide- or polysemicarbazide functional compound and/or carbodihydrazide are present in the mixture as a fine powder or as dispersion in a material that is non-reactive towards the hydrazide or semicarbazide function. This is favourable for reasons described in WO-123451.

By applying the conditions mentioned above a very useful and effective process is obtained.

The other functional groups which are present in the coating mixture may be incorporated in the polyisocyanate or are present in another compound or polymer. The other functional group may be a ketone, anhydride, epoxide, hydrazide or semicarbazide with a lower reactivity or a different particle size, isocyanate with a different reactivity, blocked isocyanate, hydroxide, melamine, hindered amine, chlorinated amine, azetidine, aspartate, carboxyl, aromatic amine, siloxane, unsaturated compound and/or cyclic carbonate.

During the second reaction step of the process, the ketone, anhydride, epoxide, isocyanate with a different reactivity, blocked isocyanate and cyclic carbonate, as well as the isocyanate in the first reaction step, react with the hydrazide or semicarbazide, but the reaction speed is lower or an increased reaction temperature is required. An alternative is that the isocyanate, ketone, anhydride, epoxide, isocyanate with a different reactivity, blocked isocyanate and cyclic carbonate react in the second step with hydroxide, carboxyl, hydrazide or semicarbazide with a lower reactivity or with a different particle size, amine, hindered amine, chlorinated amine, a polymer protected amine, blocked amine, azetidine, aspartate and aromatic amine, which may be present in the coating mixture. The melamine may either undergo a self-condensation reaction or react with the isocyanate or with likewise present ketone, anhydride, epoxide or cyclic carbonate functions. The siloxane function undergoes a self-condensation reaction after the addition of water and/or acid or after exposure to ambient moisture. The unsaturated compound undergoes a self-addition reaction after radical or UV-initiation.

When necessary, suitable conventional catalysts may be added prior to the second reaction step. This catalytic effect may also be achieved by incorporation of an acid function in the polyisocyanate functional compound, which is preferably a carboxylic acid function.

After the application of the coating mixture onto a substrate, the substrate coated with the coating mixture is preferably treated at an elevated temperature between 50 to 200° C. to effect the first reaction step in which the first reactive system substantially reacts and the second reactive system is only slightly or not reacted.

In the process of the invention the polyisocyanate-functional compound, the hydrogen-functional compound and, optionally, a compound with one or more of the other functional groups described above and/or a catalyst are mixed together, whereafter the obtained mixture is applied onto a substrate and the thus obtained coated or impregnated substrate is heated in a first reaction step to a temperature from 50 to 200° C. for 0.5 to 10 min, whereafter the formed intermediate material is treated in a second step by:
embossing or otherwise remoulding, followed by heating to a temperature from 10 to 100° C. above that of the first reaction step, or
heating to a temperature from 10 to 100° C. above that of the first reaction step, under which conditions the intermediate material melts or softens, followed by embossing and/or remoulding the material, or
applying of a second substrate onto the intermediate material, followed by, whether or not under pressure, lamination of the second substrate in the intermediate coating at a temperature between 10 and 100° C. above that of the first reaction step, under which conditions the intermediate material further cures, followed by elimination of the first substrate, or
embossing and/or remoulding otherwise, optionally at elevated temperatures, for example at a temperature between 10 and 100° C. above that of the first reaction step, followed by curing after radical or UV-initiation, or
welding or applying as sealing to other materials or to the same material at a temperature between 10 and 100° C. above that of the first reaction step.

If the mixture contains polyisocyanate-as well as, ketone-, epoxide-, anhydride- or cyclic carbonate-functional compounds, the stoichiometric ratio of the total amount of isocyanate and/or ketone and/or epoxide and/or anhydride and/or cyclic carbonate to the polyhydrazide- and/or semicarbazide- functional compound, carbodihydrazide, hydrazide- or semicarbazide functional compound with a lower reactivity or with a different particle size, amine, hindered amine, chlorinated amine, a polymer protected amine, blocked amine, azetidine, aspartate, carboxyl, aromatic amine, hydroxide, and/or melamine is between 3:1 and 1:3 and preferably between 1.5:1 and 1:1.5.

Systems which contain polyisocyanate- as well as ketone-, epoxide-, anhydride-, melamine-, siloxane-, unsaturated- and/or cyclic carbonate-functional groups, the ratio of the isocyanate groups to the ketone-, epoxide-, anhydride-, melamine-, siloxane-, unsaturated- and/or cyclic carbonate- functional group is between 20:1 and 1:20 and preferably between 10:1 and 1:10.

The two-step reaction can be used in several applications. After the formation of the intermediate coating this can be embossed or remoulded otherwise.

In a manner similar to the one described in the above mentioned patent publication all the necessary and for the coating relevant additives that are essential for the application and properties may be present, the mixture may be applied to various substrates and various techniques may be used.

The invention will now be further elucidated with reference to the following non-limiting examples. It goes without saying that many other embodiments are possible, all within the protective scope of the invention.

### EXAMPLES

### Example 1

### Preparation of an Isocyanate Functional Polyurethane Prepolymer

Under a nitrogen atmosphere 112.78 g (507.56 mmol) 3-isocyanatomethyl-3,5,5-trimethylcyclohexylisocyanate (obtainable from Huls as isophoronediisocyanate, and in the following indicated as IPDI) was added at 60-70° C. to a mixture of 139.21 g (138.24 mmol) of polypropylene glycol with a molecular weight of 1007, 163.77 g (81.89 mmol) of polypropylene glycol with a molecular weight of 2000 and 4.2 g (31.34 mmol) of trimethylolpropane while stirring. The mixture was heated to 100° C. and was reacted for two hours at this temperature under formation of a polyurethane prepolymer. After 1 hr of reaction time 0.1 g of tinoctoate was added as a catalyst. The reaction mixture was cooled down. The remaining NCO-content was measured and was 4.26%.

### Example 2

### Preparation of an Isocyanate Functional Polyurethane Prepolymer

The procedure of Example 1 was repeated, with the exception that a polyurethane prepolymer was prepared from 188.89 g (850 mmol) of IPDI, 402.8 g (400 mmol) of polypropylene glycol with a molecular weight of 1007 and 9.0 g (100 mmol) of 1,3-butanediol. The remaining NCO-content was measured and was 4.48%.

### Example 3

### Preparation of an Isocyanate- and Ketone-Functional Polyurethane Prepolymer

The procedure of Example 1 was repeated, with the exception that a polyurethane prepolymer was prepared from 188.89 g (850 mmol) of IPDI, 314.66 g (157.33 mmol) of polypropylene glycol with a molecular weight of 2000, 172.78 g (171.58 mmol) of polypropylene glycol with a molecular weight of 1007 and 169.1 g (120.61 mmol) of a ketone functional polyester diol (obtainable from NeOResins as PEC 205). The remaining NCO-content was measured and was 3.77%.

### Example 4

### Preparation of an Isocyanate- and Trimethylsiloxane-Functional Polyurethane

Under a nitrogen atmosphere 4.72 g 3-(trimethoxysilyl)propylamine was added to 120 g of the product of Example 1 while stirring. The mixture was stirred for 15 min. The remaining NCO-content was 3.26%.

### Example 5

### Preparation of an Isocyanate Functional Polyurethane Containing Incorporated Unsaturated Groups

Under a nitrogen atmosphere 4.55 g of a hydroxy functional polyesteracrjlate (obtainable as Tone M-100 from Union Carbide) and 0.02 g of dibutyltindilaureate was added to 120 g of the product of Example 1 while stirring. The mixture was stirred for 1.5 hr at 90° C. and cooled down. The remaining NCO-content was 3.40%. Just before testing of the product in Example 7, 0.4 g of an UV-initiator (CGI-1800 van Ciba) in 4 g of dipropylene glycol-dimethylether was stirred into 50 g of the mixture.

### Example 6

### Preparation of a Mixture of an Isocyanate-Functional Polyurethane and a Melamine Functional Compound

Under a nitrogen atmosphere 100 g of the product of Example 2 was mixed with 3 g of a melamine-functional resin (obtainable as Cymel 303 from Cytec). The remaining NCO-content was 4.12%.

### Example 7

### Evaluation of the Two-Step Reactions Using the Products of the Examples 1 to 6

50 g of the products of the examples 1 to 6 were mixed with an equivalent amount (with respect to the remaining NCO content) of a 1:1 dispersion of adipic dihydrazide in castor oil and with 1 g of a black pigment dispersion (obtainable as PermaQure EX-60-266/15 from Stahl Holland). An additional amount of 3.27 g of the dispersion of adipic dihydrazide in castor oil was added to the product of Example 3 as an equivalent amount of the ketone functions. Films of a thickness of 200 μm were prepared and they were heated for 2 min at 160° C. The films obtained were flexible and dry. The films were embossed by pressing a pattern into the films for 20 sec at 200° C. and 6.10⁵ Pa (6 atm.). The results of the embossing test are presented in Table I. A film of Example 5 was, after the embossing, further cured by exposing the film to UV-radiation at 240 nm and a total of energy of 4000 mJ/cm.

Next, the embossed films were placed for 24 hrs at 120° C. to test the stability of the embossing. The results are presented in Table I.

TABLE I

| | | Stability |
|---|---|---|
| Product of example: | Embossability | of the print at 120° C. |
| 1 | poor | print remains poor |
| 2 | good | print disappears |
| 3 | good | good |
| 4 | good | good |
| 5 - without UV-radiation | good | moderate |
| - with UV-radiation | good | good |
| 6 | good | good |

Remarks relating to Table I:
The second reaction step occurs during the embossing (Examples 3, 4, 6) or during the UV-curing (Example 5);
By adding a melamine resin to the product of Example 2, a better stability of the print in the film is obtained
By adding additional functions to the polyurethane prepolymer of Example 1 a better embossing is acquired and the print is fixed by the second reaction step.
By curing of the embossed film of product 5 with UV-radiation the print is fixed.

1. A process for the preparation of a coating, a coated substrate, an adhesive, film or sheet, the process comprising:
preparing a coating mixture containing a reactive system;
applying the coating mixture onto a substrate resulting in a substrate coated with the coating mixture; and
reacting the reactive system; and wherein
the coating mixture is prepared as a mixture comprising a first and a second reactive system, and after the application of the coating mixture the first reactive system is substantially reacted under conditions where the second reactive system is substantially not reacted;
after substantially reacting the first reactive system at elevated temperatures the coating substrate is remoulded, resulting in a remoulded coating; and
the second reactive system is substantially reacted during or after the remoulding of the coated substrate, resulting in a fixed remoulded coating whereby the first reactive system and the second reactive system are essentially reacted as a sequential two-step reaction.

2. The process according to claim 1, wherein the coating mixture is prepared such that one reactive system from the first and the second reactive system comprises i) a compound with at least one isocyanate functionality, and ii) a compound with at least one reactive hydrogen, and the selected reactive system is non-reactive or hardly reactive at room temperature.

3. The process according to claim 2, wherein the compound containing reactive hydrogen is a polyhydrazide-and/or polysemicarbazide-functional compound and/or carbodihydrazide.

4. The process according to claim 3, wherein the compound containing reactive hydrogen is present in the mixture at ambient temperature as a fine powder or as a dispersion in a material which is non-reactive towards the reactive hydrogen.

5. The process according to claim 2, wherein the other reactive system comprises on one hand a ketone, anhydride, epoxide, a polyisocyanate with a different reactivity, a blocked isocyanate and/or a cyclic carbonate function, or the isocyanate functional compound from claim 2 and on the other hand a hydrazide or semicarbazide with a lower reactivity or with a different particle size, an amine, hindered amine, chlorinated amine, a polymer protected amine, blocked amine, azetidine, aspartate, carboxyl, aromatic amine, hydroxide and/or melamine function and/or that the other reactive system comprises polyalkylsilozane or melamine functions which are polymerisable by self-condensation, and/or that the other reactive system comprises an unsaturated compound which undergoes an addition polymerization.

6. The process according to claim 5, wherein the compound containing at least one isocyanate functionality also contains another functional group according to claim 5 which is not reactive towards the isocyanate function.

7. The process according to claim 5, wherein the compound containing the isocyanate functionality also contains another functionality according to claim 5, which is reactive with the compound with at least one reactive hydrogen.

8. The process according to claim 5, wherein the dispersion with the polyhydrazide- and/or polysemicarbazide-functional compound and/or carbodihydrazide also contains another functional group according to claim 5 which is not reactive with the polyhydrazide- and/or polysemicarbazide-functional compound and/or carbodihydrazide.

9. The process according to claim 2, wherein the compound containing at least one isocyanate functionality contains an acid function.

10. The process according to claim 1, wherein after the application of the coating mixture onto a substrate to provide a substrate coated with the coating mixture, the coated substrate is treated at an elevated temperature between 50 to 200° C. to effect the first reaction step in which the first reactive system substantially reacts and the second reactive system is only slightly or not reacted.

11. The process according to claim 2, wherein the compound containing at least one isocyanate functionality and the reactive hydrogen-functional compound are mixed together, whereafter the obtained mixture is applied onto a substrate and the thus obtained coated or impregnated substrate is heated in a first reaction step to a temperature of 50 to 200° C. for 0.5 to 10 minutes, whereafter the formed intermediate material is treated in a second step by:
embossing or remoulding, followed by heating to a temperature from 10 to 100° C. above that of the first reaction step, or
heating to a temperature from 10 to 100° C. above that of the first reaction step, under which conditions the intermediate material melts or softens, followed by embossing and/or remoulding of the material, or
applying of a second substrate onto the intermediate material, followed by, whether or not under pressure, lamination of the second substrate in the intermediate coating at a temperature between 10 and 100° C. above that of the first reaction step, under which conditions the intermediate material further cures, followed by elimination of the first substrate, or
embossing and/or remoulding, followed by curing after radical or UV-initiation, or
welding or applying as sealing to other materials or to the same material at a temperature between 10 and 100° C. above that of the first reaction step.

12. The process according to claim 2, wherein a stoichimetric ratio of a total amount of isocyanate-, ketone-, epoxide-, anhydride- or cyclic carbonate-functional compounds to polyhudrazide and/or semicarbazide functional compound, carbodihydrazide, hydrazide- or semicarbazide-functional compound with a lower reactivity or with different particle size, amine, hindered amine, chlorinated amine, an amine protected by a polymer, blocked amine, azetidine, aspartate, carboxyl, aromatic amine, hydroxide, and/or melamine is between 3:1 and 1:3.

13. The process according to claim 2, wherein a ratio of isocyanate groups to ketone-, epoxide-, anhydride, melamine-, siloxane-, unsaturated and/or cyclic carbonate-functional groups is between 20:1 and 1:20.

14. The process according to claim 2, wherein the compound with at least one isocyanate functionality is a polyisocyanate.

15. The process according to claim 9, wherein the acid function is a carboxylic acid function.

16. The process according to claim 11, wherein the obtained mixture further comprises the other reactive system and/or a catalyst.

17. The process according to claim 11, wherein the embossing and/or remoulding step followed by curing is at elevated temperatures of between 10 and 100° C. above that of the first reaction step.

18. The process according to claim 12, wherein the stoichiometric ratio is between 1.5:1 and 1:1.5.

19. The process according to claim 13, wherein the ratio is between 10:1 and 1:10.

20. Cured product obtained by a process according to claim 1.
